(19) United States
(12) Patent Application Publication
(10) Pub. No.: US 2013/0203910 A1
(43) Pub. Date: Aug. 8, 2013

(54) FLAME RESISTANT POLYAMIDE RESIN COMPOSITION AND ARTICLES COMPRISING THE SAME

(71) Applicants: Wei W. Zhang, Shanghai (CN); Nanjian Sun, Shanghai (CN)

(72) Inventors: Wei W. Zhang, Shanghai (CN); Nanjian Sun, Shanghai (CN)

(73) Assignee: E I DU PONT DE NEMOURS AND COMPANY, Wilmington, DE (US)

(21) Appl. No.: 13/636,343

(22) PCT Filed: Mar. 28, 2011
(86) PCT No.: PCT/US11/30146

§ 371 Date: Oct. 22, 2012

(30) Foreign Application Priority Data
Mar. 30, 2010 (CN) 201010139970.1

(51) Int. Cl. C08L 77/10

(52) U.S. Cl. CPC C08L 77/10
USPC 524/133; 524/538; 524/405

(57) ABSTRACT

Disclosed is polyamide resin composition including a polyamide resin, at least one reinforcing agent, and at least one flame retardant, wherein, (a) the polyamide resin includes at least one aliphatic polyamide and an aromatic polyamide blend including at least one semi-crystalline semi-aromatic polyamide and at least one amorphous semi-aromatic polyamide; (b) based on the total weight of the polyamide resin, about 35 to about 70 wt % of the at least one aliphatic polyamide and about 30 to about 65 wt % of the aromatic polyamide blend are present in the polyamide resin; and (c) based on the total weight of the aromatic polyamide blend, about 15 to about 80 wt % of the at least one semi-crystalline semi-aromatic polyamide and about 20 to about 85 wt % of the at least one amorphous semi-aromatic polyamide are present in the aromatic polyamide blend.

### FIELD OF THE INVENTION

The present disclosure relates to a flame resistant polyamide resin composition which exhibits both good surface appearance and high gloss retention after being exposed to high temperature and humidity environment.

### BACKGROUND OF THE INVENTION

Portable electronic devices, such as mobile telephones, personal digital assistants, laptop computers, tablet computers, global positioning system receivers, portable games, radios, cameras and camera accessories, and the like are becoming increasingly widely used globally in many different environments. It is often important that the housings of such devices be made from materials that are able to withstand the rigors of frequent use and can meet challenging aesthetic demands while not interfering with their intended operability. For example, it is desirable that such housing materials have good stiffness and impact resistance and that they exhibit low warpage, high dimensional stability, good surface appearance, and good flame retardancy. In addition, as those portable electronic devices may be used at high temperature and high humidity environment, it is still desirable that the housing materials exhibit high gloss retention under such conditions.

Polyamide resins have been used as housing materials for portable electronic devices because of their good physical properties.

For example, U.S. Patent Publication No. 2008/0132633 discloses polyamide resin composition comprising fibrous reinforcing agents having non-circular cross sections, which exhibits low warpage. By “warpage” is meant the deformation of molded parts in one or more direction that may be caused by anisotropic shrinkage of the resin during molding.

U.S. Provisional Patent Application No, 61/164,572 discloses a polyamide resin composition containing semi-crystalline polyamide, amorphous polyamide, non-halogenated flame retardant, zinc borate, and fillers, which exhibits high stiffness and hardness, low warpage, and good external appearance.

U.S. Patent Publication No. 2008/0167415 describes reinforced polyamide molding materials with high notched impact strength, comprising an aliphatic semi-crystalline polyamide, an amorphous polyamide and fibrous reinforcing agents having non-circular cross sections.

However, it is found that none of the prior polyimide resin compositions exhibits good surface appearance, acceptable flame retardancy, as well as high gloss retention under high temperature and humidity conditions.

### SUMMARY OF THE INVENTION

Provided here is a polyamide resin composition comprising a polyamide at least one flame retardant, and at least one reinforcing agent, wherein, (a) the polyamide resin comprises at least one aliphatic polyamide and an aromatic polyamide blend comprising at least one semi-crystalline semi-aromatic polyamide in and at least one amorphous semi-aromatic polyamide; (b) based on the total weight of the polyamide resin, about 35 to about 70 wt % of the at least one aliphatic polyamide and about 30 to about 65 wt % of the aromatic polyamide blend are present in the polyamide resin; and (c) based on the total weight of the aromatic polyamide blend, about 15 to about 80 wt % of the at least one semi-crystalline semi-aromatic polyamide and about 20 to about 85 wt % of the at least one amorphous semi-aromatic polyamide are present in the aromatic polyamide blend. Or, based on the total weight of the polyamide resin, about 40 to about 70 wt %, or preferably about 45 to about 65 wt % of the at least, one aliphatic polyamide and about 30 to about 60 wt %, or preferably about 35 to about 55 wt % of the aromatic polyamide blend are present in the polyamide resin; and based on the total weight of the aromatic polyamide blend, about 20 to about 70 wt %, or preferably about 20 to about 60 wt % of the at least one semi-crystalline semi-aromatic polyamide and about 30 to about 80 wt %, or preferably about 40 to about 80 wt % of the at least one amorphous semi-aromatic polyamide are present in the aromatic polyamide blend.

The at least one aliphatic polyamide used herein may be selected from the group consisting of polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15: polyamide 6,16; polyamide 9,36; polyamide 10,10; polyamide 10,12; polyamide 10,13; polyamide 10,14: polyamide 12,10; polyamide 12,12; polyamide 12,13; polyamide 12,14; polyamide 6,14; polyamide 6,13; polyamide 6,15; polyamide 6,13; and combination of two or more thereof.

The at least one semi-crystalline semi-aromatic polyamide used here may be selected from the group consisting of polyamide MXD,6; polyamide 12,T; polyamide 10,T; polyamide 9,T; polyamide 6T/6,6; polyamide 6,T6,I; polyamide 6,T/D,T; polyamide 6,6/6,T/6, I; polyamide 6/6,T; and combination of two or more thereof.

The at least one amorphous semi-aromatic polyamide used here may be selected from the group consisting of polyamide 6,I/6,T; polyamide 6,I; polyamide MXD,I/6,I; polyamide MXD,I/MXD,T/6,I/6,T; polyamide MXD,I/12,I; polyamide MXD,I; polyamide MACM,I/12; polyamide MACM,I/MACM, T/12; polyamide 6,I/MACM,I/12; polyamide 6,I/6,T/MACM,I/MACM,T, polyamide 6,I/6,T/MACM,I/MACM,T/12; polyamide MACM,I/MACM,12; and combination of two or more thereof.

In one embodiment, the at least one aliphatic polyamide comprised in the polyamide resin composition comprises polyamide 6,6; the at least one semi-crystalline semi-aromatic polyamide comprised in the polyamide resin composition comprises polyamide 6,T/6,6; and the at least one amorphous semi-aromatic polyamide present in the polyamide resin composition comprises polyamide 6,I/6,T.

In a further embodiment, the at least one flame retardant comprised in the polyamide resin composition is present in the polyamide resin composition at a level of about 5 to about 45 wt % relative to the weight of the polyamide resin. Preferably, the at least one flame retardant is halogen-free. Or preferably, the at least one halogen-free flame retardant comprises at least one selected from phosphinates of the formula (I), disphosphinates of the formula (II), and combinations or polymers thereof.

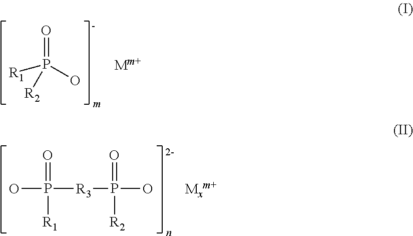

wherein R₁ and R₂ are identical or different and each of R₁ and R₂ is a linear or branched C₁-C₆ alkyl group or an aryl group; R₃ is a linear or branched C₁-C₁₀ alkylene group, a C₆-C₁₀ arylene group, an alkyl-arylene group, or an aryl-alkylene group; M is selected from calcium ions, magnesium ions, aluminum ions, zinc ions, and combinations thereof; m is an integer of 2 or 3; n is an integer of 1 or 3; and x is an integer of 1 or 2. And the at least one flame retardant may further comprise one or more selected from the group consisting of condensation products of melamine, reaction products of melamine with phosphoric acid, reaction products of condensation products of melamine with phosphoric acid, and combinations of two or more thereof.

In yet further embodiment, the at least one reinforcing agent is present in the polyamide resin composition at a level of about 20 to about 60 wt %, based on the total weight of the polyamide resin composition. The at least one reinforcing agent may be selected from the group consisting of organic fillers, inorganic fillers, and mixtures thereof and the inorganic fillers may be selected from the group consisting of glass fibers, carbon fibers, whiskers of wollastonite, whiskers of potassium titanate, montmorillonite, talc, mica, calcium carbonate, silica, clay, kaolin, glass powder, glass beads, and mixtures of two or more thereof. Preferably, the at least one reinforcing agent may comprise glass fibers, preferably glass fibers with non-circular cross sections, and wherein the at least one reinforcing agent is present in the polyamide resin composition at a level of about 35 to about 60 wt %, or preferably about 40 to about 55 wt %, based on the total weight of the polyamide resin composition.

In a yet further embodiment, the polyamide resin composition may further comprise one or more other additives selected from the group consisting of flame retardant synergists, zinc borate, other polymers, impact modifiers, ultraviolet light stabilizers, heat stabilizers, antioxidants, flow enhancers, processing aids, lubricants, colorants, and combinations of two or more thereof.

Further provided here is an article comprising the polyamide resin composition described above. The article may be a molded article and the molded article may be a housing part for a portable electronic device. And the portable electronic device may be selected from the group consisting of mobile telephones, personal digital assistants, laptop computers, tablet computers, global positioning system receivers, portable games, radios, and cameras and camera accessories.

### DETAILED DESCRIPTION OF THE INVENTION

Disclosed herein is a polyamide resin composition comprising a polyamide resin, at least one flame retardant, and at least one reinforcing agent, wherein the polyamide resin comprises at least one aliphatic polyamide and an aromatic polyamide blend comprising at least one semi-crystalline semi-aromatic polyamide and at least one amorphous semi-aromatic polyamide. About 35 to about 70 wt % of the aliphatic polyamide and about 30 to about 65 of the aromatic polyamide blend, based on the total weight of the polyamide resin, may be present in the polyamide resin, while the aromatic polyamide blend may comprise about 15 to about 80 wt % of the at least one semi-crystalline semi-aromatic polyamide and about 20 to about 85 wt % of the at least one amorphous semi-aromatic polyamide, based on the total weight of the aromatic polyamide blend.

The aliphatic polyamide used here refers to a polyamide containing no aromatic ring in the molecular chain, which is a polyamide wherein an aminocarboxylic acid, a lactam, or a diamine and a dicarboxylic add are used as main starting material(s).

The aminocarboxylic acids used here may be aminocarboxylic acids having 6 to 12 carbon atoms, which include, but are not limited to, 6-aminocapronic acid, 7-aminoheptanoic acid, 9-aminononanoic acid, 11-aminoundecanoic acid, 12-aminododecanoic acid, and the like.

The lactam used here may be lactams having 4 to 12 carbon atoms which include, but are not limited to, α-pyrrolidone, ε-caprolactam, ω-laurolactam, ε-enantholactam, and the like.

The diamine used here may be aliphatic or alicyclic diamines, including but not limited to, tetramethylenediamine, hexamethylenediamine, 2-methylpentamethylenediamine, nonamethylenediamine, undecamethylenediamine, dodeca-methylenediamine, 2,2,4-trimethylhexamethylenediamine, 2,4,4-trimethylhexemethylenediemine, 5-methylnonamethylene-diamine, 1,3-bis(aminomethyl)cyclohexane, 1,4-bis(aminomethyl)cyclohexane, 1-amino-3-aminometyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, aminoethylpiperazine, bis(p-aminocyclohexyl)methane; 2-methyloctamethylenediamine; trimethylhexamethylenediamine; 1,8-diaminooctane: 1,9-diaminononane; 1,10-diaminodecane; 1,12-diaminododecane; and m-xylylenediamine and the like.

The dicarboxylic acid used here may be aliphatic or alicyclic dicarboxylic acids, including but not limited to, adipic acid, glutaric acid, pimelic acid, suberic a azelaic acid, sebacic acid, dodecanedioic acid, 1,4-cyclohexanedicarboxylic acid, and the like.

Examples of preferred aliphatic polyamides include, but are not limited to, polyamide 6; polyamide 6,6; polyamide 4,6; polyamide 6,10: polyamide 6,12; polyamide 11; polyamide 12; polyamide 9,10; polyamide 9,12; polyamide 9,13; polyamide 9,14; polyamide 9,15: polyamide 6,16; polyamide 9,36; polyamide 10,10; polyamide 10,12; polyamide 10,13; polyamide 10,14; polyamide 12,10: polyamide 12,12; polyamide 12,13; polyamide 12,14: polyamide 6,14; polyamide 6,13: polyamide 6,15; polyamide 6,16; and polyamide 6,13. In one embodiment, the at least one aliphatic polyamide comprised in the polyamide resin is polyamide 6,6.

The semi-aromatic polyamides used herein include homopolymers, copolymers, terpolymers, or higher polymers containing at least one aromatic monomer component. For example, a semi-aromatic polyamide may be obtained by using an aliphatic dicarboxylic acid and an aromatic diamine, or an aromatic dicarboxylic acid and an aliphatic diamine as starting materials and subjecting them to polycondensation. The aliphatic diamine and aliphatic dicarboxylic acid used in the above mentioned aliphatic polyamide may be used here. Suitable aromatic diamines may include, but are not limited to, m-xylylenediamine, p-xylylenediamine, and the like. Suitable aromatic dicarboxylic acids may include, but are not limited to, naphthalenedicarboxylic acid, terephthalic acid, isophthalic acid, phthalic acid, and the like.

The term “semi-crystalline” used here means that heat of crystal melting measure on a differential scanning calorimeter (DSC) is at least about 5 cal/g. The semi-crystalline semi-aromatic polyamides may be a polyamide containing at least one aromatic monomer component. Examples of preferred semi-crystalline semi aromatic polyamides include, but are not limited to, poly(m-xylylene adipamide) (polyamide MXD,6), poly(doclecamethylene terephthalamide) (polyamide 12,T), poly(decamethylene terephthalamide) (polyamide 10, T), poly(nonamethylene terephthalamide) (polyamide 9,T), hexamethylene adipamide/hexamethylene terephthalamide copolyamide (polyamide 6, T/6,6), poly(hexamethylene terephthalamide/hexamethylene isophthalamide) (polyamide 6T/6,I) (e.g., polyamide 6,T/6.1 having at least about 55 mol % of its repeating units derived from 6T), hexamethylene terephthalamide/2-methylpentamethylene terephthalamide copolyamide (polyamide 6,T/D,T); hexamethylene adipamidethexamethylene terephthalamide/hexamethylene isophthalamide copolyamide (polyamide 6, 6/6,T/6,I); poly(caprolactam-hexamethylene terephthalamide) (polyamide 6/6,T); and the like. In one embodiment, the semi-crystalline semi-aromatic polyamide used herein is polyamide 6, T/6,6.

The term “amorphous”herein means that heat of crystal melting measured on DSC is about 1 cal/g or less. The amorphous semi-aromatic polyamide used herein may be a polyamide containing at least two aromatic monomer components. Examples of preferred amorphous semi-aromatic polyamides include, but are not limited to, poly(hexamethylene isophthalamide/hexamethylene terephthalamide) (polyamide 6,I/6,T) (e.g., polyamide 6,I/6,T having at least about 55 mol % of its repeating units derived from 6,I), poly(hexamethylene isophthalamide) (polyamide 6,I), poly(metaxylylene isophthalamide/hexamethylene isopnthalamide) (polyamide MXD, I/6,I), poly(metaxylylene isophthalamide/metaxylylene terephthalamide/hexamethylene isophthalamide) (polyamide MXD,I/MXD,T6,I/6,T), poly(metaxylylene isophthalamide/dodecamethylene isophthalamide) (polyamide MXD, I/12,I), poly(metaxylylene isophthalamide) (polyamide MXD,I), poly(dimethyldiaminodicyclonexylmethene isophthalamide/dodecanamide) (polyamide MACM,I/12), poly(dimethyldiaminodicyclohexylmethane isophthalamide/dimathyldiaminodicyclohexylmethane terephthalamide/dodecanamide) (polyamide MACM,I/MACM,T12), poly(hexamethylene isophthalamide/dimethyldiaminodicyclohexamethylene isophthalamide/dodecanamide) (polyamide 6,I/MACM,I/12), poly(hexamethylene isophthalamide/hexamethylene terephthalamide/dimethyldiaminodicyclohexylmethane isophthalamid/dimethyldiaminodicyclonexylmethane terephthalamide) (polyamide 6,I/6,T/MACM,I/MACM,T1/2), poly(hexamethylene isophthalamide/hexamethylene terephthalamide/dimethyldiaminodicyclohexylmethane isophthalamid/dimethyldiaminodicyclohexylmethane terephthalamide/dodecanamide) (polyamide 6,I/6,T/MACM,I/MACM,T12), poly(dimethyldiaminodicyclohexylmethane isophthalamide/dimethyldiaminodicyclchexylmethane dodecanamide) (polyamide MACM,I/MACM,12) and the like. In one embodiment, the amorphous semi-aromatic polyamide used herein is polyamide 6,I/6, T. For example, the polyamide 6,I/6,T used here may contain at least about 60 mol %, or preferably at least about 65 mol % of its repeating units derived from 6,I.

Based on the total weight of the polyamide resin, the at least one aliphatic polyamide may be present in the polyamide resin at a level of about 35 to about 70 wt %, preferably about 40 to about 70 wt %, more preferably about 45 to about 65 wt %. Based on the total weight of the polyamide resin, the aromatic polyamide blend may be present in the polyamide resin at a level of about 30 to about 65 wt %, preferably about 30 to about 60 wt %, more preferably about 35 to about 55 wt %. Based on the total weight of the aromatic polyamide blend, the at least one semi-crystalline semi-aromatic polyamide may be present in the blend at a level of about 15 to about 80 wt %, preferably about 20 to about 70 wt %, more preferably about 20 to about 60 wt %, and the at least one amorphous semi-aromatic polyamide may be present in the blend at a level of about 20 to about 85wt %, preferably about 30 to about 80 wt %, more preferably about 40 to about 80 wt %.

The at least one flame retardant may be any suitable flame retardant, including both halogen-containing and halogen-free compounds. However, due to toxicity concerns in addition to other disadvantages halogen-free flame retardants are preferred.

Suitable halogen-free flame retardants include, but are not limited to, red phosphorus (see e.g., DE1 931 387), magnesium hydroxide (see e.g., DE 95 25 873), nitrogen-containing flame retardants (such as melamine cyanurate, see e.g., EP 0 614 933) phosphorus/nitrogen-containing flame retardants (such as melamine-polyphosphate, see e.g., EP 0 782 599), phosphorus compounds (such as salts of phosphinic or diphosphinic acids, see e.g., EP 0 792 912 and US 2007/0072970), and mixtures of two of more thereof.

In one embodiment, the at least one flame retardant comprises at least one selected from phosphinates of the formula (I), disphosphinates of the formula (II), and combinations or polymers thereof.

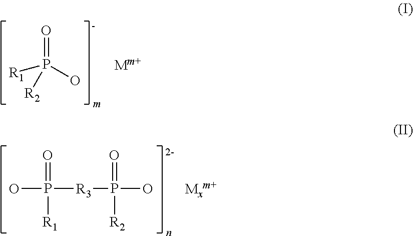

wherein R₁ and R₂ may be identical or different and each of R₁ and R₂ is a linear or branched C₁ -C₆ alkyl group or an aryl group; R₃ is a linear or branched C₁-C₁₀ alkylene group, a C₆-C₁₀ arylene group, an alkyl-arylene group, or an aryl-alkylene group; M selected from calcium ions, magnesium ions, aluminum ions, zinc ions and combinations thereof; m is an integer of 2 or 3; n is an integer of 1 or 3; and x is an integer of 1 or 2. Preferably R₁ and R₂ may be independently selected from methyl, ethyl, n-propyl, isopropyl, n-butyl, tert-butyl, n-pentyl, and phenyl; R₃ may be selected from methylene, ethylene, n-propylene, isopropylene, n-butylene, tert-butylene, o-pentylene, n-octylene, n-dodecylene, phenylene, naphthylene, methylphenylene, ethylphenylene, tert-butylphenylene, methylnaphthylene, ethylnaphthylene, butylnaphthylene, phenylmethylene, phenylethylene, phenylpropylene, and phenylbutylene, and M may be selected from aluminum and zinc ions. More preferably, the phosphinates used here may be selected from aluminum methylethylphosphinate, aluminum diethylphosphinate, and combinations thereof. In addition to the phosohinates, the at least one flame retardant may further comprise one or more selected from condensation products of melamine, reaction products of melamine with phosphoric acid, reaction products of condensation products of melamine with phosphoric acid, and combinations of two or more thereof. Such flame retardants are disclosed in U.S. Pat. No. 6,255,371, which is incorporated herein by reference.

In the polyamide resin composition, the at least one flame retardant may be present at a level of about 5 to about 45 wt %, relative to the weight of the polyamide resin.

The polyamide resin composition may further comprise one or more flame retardant synergists. Exemplary flame retardant synergists include, but are not limited to, silicone, metal oxides (such as silica, boehmite, aluminum oxide, iron, oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide and tungsten oxide), metal powder (such as aluminum, iron, titanium, manganese, zinc, molybdenum, cobalt, bismuth, chromium, tin, antimony, nickel, copper and tungsten), and metal salts (such as barium metaborate, zinc carbonate, magnesium carbonate, calcium carbonate, and barium carbonate). Preferred flame retardant synergists are boehmite (aluminum hydroxide oxide (AIO(OH))) and/or aluminum oxide. When used, the one or more flame retardant synergists are present at about 1 to about 20 wt %, based on the combined weight of the at least one flame retardant and the at least one flame retardant synergist.

Based on the total weight of the polyamide resin composition, the at least one reinforcing agent may be present at a level of about 23 to about 60 wt %, preferably about 35 to about 60 wt %, more preferably about 40 to about 55 wt %. Suitable reinforcing agents may be selected from fibrous inorganic materials (such as glass fibers, carbon fibers, and whiskers of wollastonite and potassium titanate), inorganic fillers (such as various montmorillonite, talc, mica, calcium carbonate, silica, clay, kaolin, glass powder, and glass beads), organic fillers (such as various organic or polymeric powders), and mixtures of two or more thereof. In one embodiment of the disclosed polyamide resin composition, the at least one reinforcing agent is selected from glass fibers. Preferably, the glass fibers used here have non-circular cross sections.

The glass fiber having a non-circular cross section refers to a glass fiber having a major axis lying perpendicular to a longitudinal direction of the fiber and corresponding to the longest linear distance in the cross section. The non-circular cross section also has a minor axis corresponding to the longest linear distance in the cross section in a direction perpendicular to the major axis. The non-circular cross section of the fiber may have a variety of shapes including a cocoon-type shape, a rectangular shape, an elliptical shape, a semielliptical shape, a roughly triangular shape, a polygonal shape, an oblong shape, and the like. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fibers having non-circular cross sections are disclosed in EP 0 190 001 and EP 0 196 194. The glass fibers may be in the form of long glass fibers, chopped strands, milled short glass fibers, or other suitable forms known to those skilled in the art.

The polyamide resin composition may yet further comprise zinc borate. By the term “zinc borate” is meant one or more compounds having the formula:

(ZnO)ₓ(B₂O₃)_{y}(H₂O)_{z}

wherein X is an integer between 2 and 4, inclusive; Y is an integer between 1 and 3, inclusive; and Z is an integer between 0 and 5, inclusive. Zinc borate can be purchased from US Borax under the tradename Firebrake®. Preferred forms of zinc borate are those in which X=4, Y=1, and Z=1 (Firebrake®415); in which X=2, Y=3, and Z=3.5 (Firebrake®290); and in which X=2, Y=3, and Z=0 (Firebrake®500).

The zinc borate may be present at a level of about 0.5 to about 5 wt %, or preferably about 1 to about 4 wt %, or more preferably about 1.2 to about 3.7 wt %, relative to the weight of the at least one flame retardant. For the purposes of determining the amount of zinc borate present, if the zinc borate is a hydrate (i.e., Z is not zero), the weight of the corresponding anhydrous form of the zinc borate is used, thus only the amounts of ZnO and B₂O₃ present in the zinc borate compound are considered to contribute to the zinc borate weight that is used in the calculation. As used herein in conjunction with the amount of zinc borate used in a composition, the term “zinc borate” refers to anhydrous form of the compound in question.

The polyamide resin composition may optionally further comprise other additional additives such as other polymers, impact modifiers, ultraviolet light stabilizers, heat stabilizers, antioxidants, flow enhancers, processing aids, lubricants, colorants (including dyes, pigments, carbon black, and the like), and combinations of two or more thereof.

The polyamide resin composition disclosed here may be prepared by melt-blending the components using any known methods. The component materials may be mixed to uniformity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until uniform.

The compositions of the invention may be formed into article any known melt-processing means such as injection molding, blow molding, extrusion, or thermoforming. Articles molded using injection molding are most preferred.

As demonstrated by the examples (see below), when compared to prior art polyamide resin compositions (CE1-4 and CE7), molded articles made of the polyamide resin compositions disclosed herein (E1-E4) exhibit both good surface appearance and low flammability. In addition, the molded articles made of the polyamide composition resin composition disclosed herein also posses good gloss retention after being exposed to high temperature and high humidity conditions. As used here, “good surface appearance” refers to those molded articles having no visible marks due to the addition of various fillers, such as glass fibers; “low flammability” refers to those molded articles having a UL-94 flammability rating (Underwriters Laboratory) of V-0; and “molded articles having good gloss retention after being exposed to high temperature and high humidity conditions” refers to those molded articles having no gloss loss after being conditioned at 60° C. and 90% relative humidity for 24 hours. Due to such properties, the polyamide resin compositions disclosed herein may be suitable as housing materials for various portable electronic devices, such as mobile telephones, personal digital assistants, laptop computers, tablet computers, global positioning system receivers, portable games, radios, cameras and camera accessories, and the like. Therefore, further disclosed herein are molded articles (such as housing parts for various portable electronic devices) comprising the polyamide resin compositions described above.

The invention will become better understood upon having reference to the following examples of the invention together with the descriptions of preparation and testing techniques and materials used.

### EXAMPLES

Compounding

The polymeric compositions shown in Table 1 were prepared by compounding in a 26 mm ZSK twin screw extruder. All ingredients were blended together and added to the rear of the extruder except that glass fibers and flame retardant were side-fed into a downstream barrel. Barrel temperatures were set at about 300-330° C. After exiting the extruder, the blended compositions were cooled and cut into pellets. The pellets were surface coated with 0.2 weight percent of calcium montanate.

Testing Methods

Tensile strength and tense elongation were determined using the ISO 527-1/2 standard method.

Flexural modulus was determined using the IS0178-1/2 standard method.

Notched charpy impact strength was measured using the ISO 179/1/eA standard method.

Gloss retention was determined with regard to the surface gloss of an ISO plate (60 mm×60 mm, 2 mm thickness) conditioned at 60° C. and 90% relative humidity for 24 hours. No optically visible gloss loss was rated as “ [symbol] ; optically visible gloss loss was rate as “X°.

UL-94 flammability rating (Underwriters Laboratory) was determined using 0.8 mm thick test bars. Prior to the testing, the bars were conditioned at 23° C. and 50% relative humidity for 48 hrs or at 70° C. for in an air oven for 168 hours.

Surface appearance was determined with regard to the surface duality of a flow spiral with 10 mm width and 2 mm thickness. Poor surface quality with optically visible white markings at the end part of a flow spiral was rated as “X” good surface quality with no optically visible white markings over the whole spiral length was rated as [symbol] .

Molded articles for the determination of tensile strength, tensile elongation, flexural modulus, notched charpy impact strength, gloss retention and flammability were produced on a Sumitomo 100T injection molding machine, wherein the cylinder temperatures were set at 295-310° C., the, molding temperature was set at 90° C. Flow spirals for the determination of surface appearance were produced on a Sumitomo 180T injection molding machine, wherein the cylinder temperatures were set at 295-310° C., the molding temperature was set at 90° C., the injection pressure was set at 80 MPa, and cooling time was set at 6-8 seconds.

Materials:

PA6T/66—Zytel® HTN 502 HF NC010 (polyamide 6,T/6,6) available from E.I. du Pont de Nemours;

PA6I/6T—Zytel® HTN 503 NC010 (polyamide 6,I/6, T), available from E.I. du Pont de Nemours;

PA66—Zytel® EFE1117 NC010 (polyamide 66), available from E.I. du Pont de Nemours;

Flame retardant—Exolit™ OP 1230, an aluminum diethylphosphinate available from Clarient;

Glass fiber—Nittobo CSG 3PA-820S available from Nittobo Co., Ltd. having a elliptical non-circular cross section. The ratio of the length of the major axis to that of the minor access is 4.

2,6-NDA—2,6-napthalene dicarboxylic acid, available from BP Amoco Chemical Company;

DDDA—dodecanedioic acid, available from invista

Zinc borate—Firebrake™ ZB, a zinc borate of the formula (ZnO)₂(B₂O₃)₃(H₂O)_{3.5} available from US Borax;

Boehmite—Celasule BMT-33, available from Kawai Sekkai Kogyo

Colorant concentrate—PAM(F) 25420 Black, available from Daini Seika Co., Ltd.

### Examples E1-E4 and Comparative Examples CE1-CE7

In E1-E4 and CE1-CE7, various polyamide resin compositions (with their components listed in Table 1) were prepared using the compounding process described above. The polyamide resin compositions were then subject to various property testing (as described above), and the results are also tabulated in Table 1.

In general, to be useful as housing materials, the composition need >to have a Flexural Modulus of 15 GPa or higher and a Notched Charpy impact strength of 11 kJ/m² or higher. As illustrated in Table 1, molded articles made of the polyamide compositions of E1-E4 (the polyamide resin compositions disclosed here) have net these requirements. In addition, when compared to CE1-CE4 and CE7, the molded articles made of the polyamide resin compositions of E1-E4 exhibit both good gloss retention and good surface appearance, while maintaining low flammability. In addition, as demonstrated by CE5 and CE6, when the aliphatic polyamide component is present at 30 wt % or less in the polyamide resin, the surface appearance of the molded article made therefrom becomes very poor and therefore not desirable for the intended end use.

TABLE 1

| | E1 | E2 | E3 | E4 | CE1 | CE2 | CE3 | CE4 | CE5 | CE6 | CE7 |
|---|---|---|---|---|---|---|---|---|---|---|---|
| PA6T/66* | 3.4 | 3.4 | 6.8 | 10.3 | 34.4 | — | 22.1 | 29.4 | 15.9 | 24.1 | — |
| PA6I/6T* | 10.3 | 13.7 | 10.3 | 6.8 | — | — | 14.7 | 7.4 | 6.3 | 6.9 | 10.3 |
| PA66* | 20.5 | 17.1 | 17.1 | 17.1 | — | 35.5 | — | — | 9.5 | 3.4 | 23.9 |
| Blend Ratio | 10/30/60 | 10/40/50 | 20/30/50 | 30/20/50 | 100/0/0 | 0/0/100 | 60/40/0 | 80/20/0 | 50/20/30 | 70/20/10 | 0/30/70 |
| ((PA6T/66)/ | | | | | | | | | | | |
| (PA6I/6T)/(PA66)) | | | | | | | | | | | |
| Flame retardant* | 13 | 13 | 13 | 13 | 11 | 13 | 9 | 9 | 14 | 11 | 13 |
| Glass fiber* | 50 | 50 | 50 | 50 | 50 | 50 | 50 | 50 | 50 | 50 | 50 |
| 2,6-NDA* | 0.5 | 0.5 | 0.5 | 0.5 | 0.7 | 0.5 | 0.7 | 0.7 | 0.7 | 0.7 | — |
| DDDA* | — | — | — | — | — | — | — | — | — | — | 0.5 |
| Zinc borate* | 0.3 | 0.3 | 0.3 | 0.3 | 0.1 | — | — | — | 0.3 | 0.1 | 0.3 |
| Boehmite* | 1 | 1 | 1 | 1 | 1.8 | — | 1.5 | 1.5 | 2.3 | 1.8 | 1 |
| Color concentrate* | 1 | 1 | 1 | 1 | 1 | 1 | 2 | 2 | 1 | 2 | 1 |

Properties

| | | | | | | | | | | | |
|---|---|---|---|---|---|---|---|---|---|---|---|
| Tensile strength | 184 | 186 | 178 | 169 | 123 | 200 | N/A** | N/A** | 145 | 155 | 166 |
| (MPa) | | | | | | | | | | | |
| Tensile Elongation | 1.5 | 1.6 | 1.4 | 1.4 | 0.9 | 1.8 | N/A** | N/A** | 1.2 | 1.2 | 1.3 |
| (%) | | | | | | | | | | | |
| Flexural Modulus | 17.9 | 17.8 | 18.2 | 17.2 | N/A** | 17.8 | N/A** | N/A** | 16.3 | 16.4 | 18.4 |
| (GPa) | | | | | | | | | | | |
| Notched Charpy | 12.4 | 12.6 | 12.6 | 11.8 | 12.2 | 11.4 | N/A** | N/A** | 10.0 | 12 | 12.7 |
| impact strength | | | | | | | | | | | |
| (kJ/m²) | | | | | | | | | | | |
| Gloss retention | ◯ | ◯ | ◯ | ◯ | ◯ | X | X | X | ◯ | X | ◯ |
| UL-94 flammability | V-0 | V-0 | V-0 | V-0 | V-0 | V-1 | N/A** | N/A** | V-1 | V-0 | V-1 |
| rating | | | | | | | | | | | |
| Surface appearance | ◯ | ◯ | ◯ | ◯ | X | ◯ | ◯ | X | X | X | ◯ |

*The amount of each component listed under each polyamide resin composition is recorded as wt % based on the total weight of the polyamide resin composition.
**N/A means test not done the sample.

1. A polyamide resin composition comprising a polyamide resin, at least one flame retardant, and at least one reinforcing agent, wherein,
a) the polyamide resin comprises at least one aliphatic polyamide and an aromatic polyamide blend comprising at least one semi-crystalline semi-aromatic polyamide and at least one amorphous semi-aromatic polyamide;
b) based on the total weight of the polyamide resin, about 35 to about 70 wt % of the at least one aliphatic polyamide and about 30 to about 65 wt % of the aromatic polyamide blend are present in the polyamide resin; and
c) based on the total weight of the aromatic polyamide blend, about 15 to about 80 wt % of the at least one semi-crystalline semi-aromatic polyamide and about 20 to about 85 wt % of the at least one amorphous semi-aromatic polyamide are present in the aromatic polyamide blend.

2. The polyamide resin composition of claim 1, wherein,
a) based on the total weight of the polyamide resin, about 40 to about 70 wt %, or preferably about 45 to about 65 wt % of the at least one aliphatic polyamide and about 30 to about 60 wt %, or preferably about 35 to about 55 wt % of the aromatic polyamide blend are present in the polyamide resin; and
b) based on the total weight of the aromatic polyamide blend, about 20 to about 70 wt %, or preferably about 20 to about 60 wt % of the at least one semi-crystalline semi-aromatic polyamide and about 30 to about 80 wt %, or preferably about 40 to about 80 wt % of the at least one amorphous semi-aromatic polyamide are present in the aromatic polyamide blend.

3. The polyamide resin composition of claim 1, wherein (i) the at least one aliphatic polyamide is selected from the group consisting of polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; polyamide 6,13; and combinations of two or more thereof, (ii) the at least one semi-crystalline semi-aromatic polyamide is selected from the group consisting of polyamide MXD,6; polyamide 12,T; polyamide 10,T; polyamide 9,T; polyamide 6,T/6,6; polyamide 6,T/6,I; polyamide 6,T/D,T; polyamide 6,6/6,T/6,I; polyamide 6/6,T; and combinations of two or more thereof, and (iii) the at least one amorphous semi-aromatic polyamide is selected from the group consisting of polyamide 6,I/6,T; polyamide 6,I; polyamide MXD,I/6,I; polyamide MXD,I/MXD,T/6,I/6,T; polyamide MXD,I/12,I; polyamide MXD,I; polyamide MACM,I/12; polyamide MACM,I/MACM,T/12; polyamide 6,I/MACM,I/12; polyamide 6,1/6,T/MACM,I/MACM,T; polyamide 6,I/6,T/MACM,I/MACM,T/12; polyamide MACM,I/MACM,12; and combinations of two or more thereof.

4. The polyamide resin composition of claim 3, wherein the at least one aliphatic polyamide comprises polyamide 6,6; the at least one semi-crystalline semi-aromatic polyamide comprises polyamide 6,T/6,6; and the at least one amorphous semi-aromatic polyamide comprises polyamide 6,I/6,T.

5. The polyamide resin composition of claim 1, wherein the at least one flame retardant is present in the polyamide resin composition at a level of about 5 to about 45 wt % relative to the weight of the polyamide resin.

6. The polyamide resin composition of claim 5, wherein the at least one flame retardant comprises at least one selected from the group consisting of phosphinates of the formula (I), disphosphinates of the formula (II), and combinations or polymers thereof 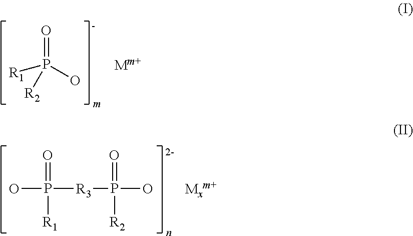
wherein R₁ and R₂ are identical or different and each of R₁ and R₂ is a linear or branched C₁-C₆ alkyl group or an aryl; R₃ is a linear or branched C₁-C₁₀ alkylene group, a C₆-C₁₀ arylene group, an alkyl-arylene group, or an aryl-alkylene group; M is selected from the group consisting of calcium ions, magnesium ions, aluminum ions, zinc ions, and combinations of two or more thereof; m is an integer of 2 or 3; n is an integer of 1 or 3; and x is an integer of 1 or 2.

7. The polyamide resin composition of claim 6, wherein the at least one flame retardant may further comprises one or more selected from the group consisting of condensation products of melamine, reaction products of melamine with phosphoric acid, reaction products of condensation products of melamine with phosphoric acid, and combinations of two or more thereof.

8. The polyamide resin composition of claim 1, wherein the at least one reinforcing agent is present in the polyamide resin composition at a level of about 20 to about 60 wt %, based on the total weight of the polyamide resin composition.

9. The polyamide resin composition of claim 8, wherein the polyamide resin composition further comprises one or more other additives selected from the group consisting of flame retardant synergists, zinc borate, impact modifiers, ultraviolet light stabilizers, heat stabilizers, antioxidants, flow enhancers, processing aids, lubricants, colorants, and combinations of two or more thereof.

10. A molded article comprising the polyamide resin composition of claim 8.

11. The molded article of claim 10, which is a housing part for a portable electronic device.

12. The molded article of claim 11, wherein the portable electronic device is selected from the group consisting of mobile telephones, personal digital assistants, laptop computers, tablet computers, global positioning system receivers, portable games, radios, and cameras and camera accessories.
